(19) United States
(12) Patent Application Publication
(10) Pub. No.: US 2011/0320471 A1
(43) Pub. Date: Dec. 29, 2011

(54) Movie Recommendation System and Movie Recommendation Method

(75) Inventors: Kazushige HIROI, Machida (JP); Konagi UCHIBE, Machida (JP); Maki FURUI, Tokyo (JP)

(73) Assignee: Hitachi Consumer Electronics Co., Ltd., Tokyo (JP)

(21) Appl. No.: 13/039,438

(22) Filed: Mar. 3, 2011

(30) Foreign Application Priority Data
Jun. 24, 2010 (JP) 2010-143927

(51) Int. Cl. G06F 17/30

(52) U.S. Cl. 707/767; 707/E17.017

(57) ABSTRACT

There is provided a movie recommendation system, including: a scene metadata obtaining module for obtaining metadata which contains keywords associated with scenes, and time axis information indicating times at which the keywords appear, the scenes included in a movie content; a movie content information obtaining module for obtaining information of a movie content to be reproduced by a user; a contents preference information obtaining module for obtaining contents preference information, which is generated by assigning preference of the user to the keywords that are contained in the obtained metadata, based on the obtained information of the movie content; and a scene recommendation module for outputting at least one keyword preferred by the user from among the keywords contained in the movie content, based on the obtained contents preference information, in association with a scene recommended to the user.

### CLAIM OF PRIORITY

The present application claims priority from Japanese patent application JP 2010-143927 filed on Jun. 24, 2010, the content of which is hereby incorporated by reference into this application.

### BACKGROUND OF THE INVENTION

This invention relates to a movie recommendation device which recommends movie contents and scenes in movie contents.

There are many television channels today, including digital terrestrial broadcasts, BS broadcasts, and CS broadcasts, and the number of television programs is increasing accordingly. There are also many movies distributed on the Internet, and the number of movie contents available to users for view is enormous. The number of movie contents that can be saved on an HDD recorder and other similar recorders is increasing, too, owing to the increased HDD capacity and the advancement in movie compression technology.

A user finds it very difficult to select movie contents of his/her taste from this many movie contents. In addition, a user can spend only a limited amount of time to view movies. Measures that enable users to efficiently view movie contents of their respective tastes are therefore sought for.

In answer, a technology has been proposed which recommends and automatically records movie contents based on user's preference information generated from the titles, genres, cast names, and the like of movies that the user viewed in the past (see, for example, JP 2000-13708 A and JP 2007-96560 A).

Another technology proposed enables a user to efficiently view only scenes that are of interest to the user by displaying keywords contained in movie data of movie contents and then letting the user select one of the keywords (see, for example, JP 2008-148077 A and JP 2009-77322 A).

### SUMMARY OF THE INVENTION

The technology described in JP 2000-13708 A and JP 2007-96560 A is a technology for recommending and automatically recording movie contents that match the preference of a user on a content basis, and is not capable of providing a user with information about which part of a movie content matches the user's preference. Therefore, when only one scene in a movie content matches the preference of a user, the user is forced to view scenes that do not match his/her preference as well and waste his/her viewing time.

JP 2008-148077 A and JP 2009-77322 A disclose a technology with which a user can select a keyword before viewing a movie content and view a scene associated with the keyword. However, a movie content may contain many keywords, and the operation of selecting one keyword from many keywords is laborious for users.

This invention has been made in view of the above, and it is an object of this invention to provide a system that enables a user to view movie contents efficiently with simple operation by recommending movie contents and scenes in movie contents that precisely match the user's preference.

A representative aspect of this invention is as follows. That is, there is provided a movie recommendation system, having: a processor for executing a software program; a memory for storing the software program; an output unit for outputting movies to be presented to the user; and an input unit for receiving an input from the user. The movie recommendation system includes: a scene metadata obtaining module for obtaining metadata which contains keywords associated with scenes, and time axis information indicating times at which the keywords appear, the scenes included in a movie content; a movie content information obtaining module for obtaining information of a movie content to be reproduced by a user; a contents preference information obtaining module for obtaining contents preference information, which is generated by assigning preference of the user to the keywords that are contained in the obtained metadata, based on the obtained information of the movie content; and a scene recommendation module for outputting at least one keyword preferred by the user from among the keywords contained in the movie content, based on the obtained contents preference information, in association with a scene recommended to the user.

According to an embodiment of this invention, a user can easily select movie contents and scenes that match his/her preference for efficient viewing.

### BRIEF DESCRIPTION OF THE DRAWINGS

The present invention can be appreciated by the description which follows in conjunction with the following figures, wherein:

FIG. 1 is a hardware configuration diagram of a movie recommendation system according to a first embodiment of this invention;

FIG. 2 is a block diagram illustrating functions of the movie recommendation system according to this embodiment;

FIG. 3 is a diagram illustrating an example of the configuration of scene metadata;

FIG. 4 is a diagram illustrating an example of the configuration of contents preference information, scene preference information, and scene recommendation information;

FIG. 5 is a diagram illustrating an example of the configuration of movie contents recommendation information;

FIG. 6 is a diagram illustrating an example of displaying movie contents recommendation information on the screen;

FIG. 7 is a diagram illustrating an example of displaying scene recommendation information on the screen;

FIG. 8 is a flow chart illustrating the concrete operation of the movie recommendation system according to the first embodiment;

FIG. 9 is a flow chart illustrating the reproduction control processing;

FIG. 10 is a block diagram illustrating functions of the movie recommendation system according to a second embodiment of this invention;

FIG. 11 is a block diagram illustrating functions of a movie recommendation system according to a third embodiment of this invention;

FIG. 12 is a block diagram illustrating functions of a movie recommendation system according to a fourth embodiment of this invention; and

FIG. 13 is a block diagram illustrating functions of a movie recommendation system according to a fifth embodiment of this invention.

### DETAILED DESCRIPTION OF THE PREFERRED EMBODIMENTS

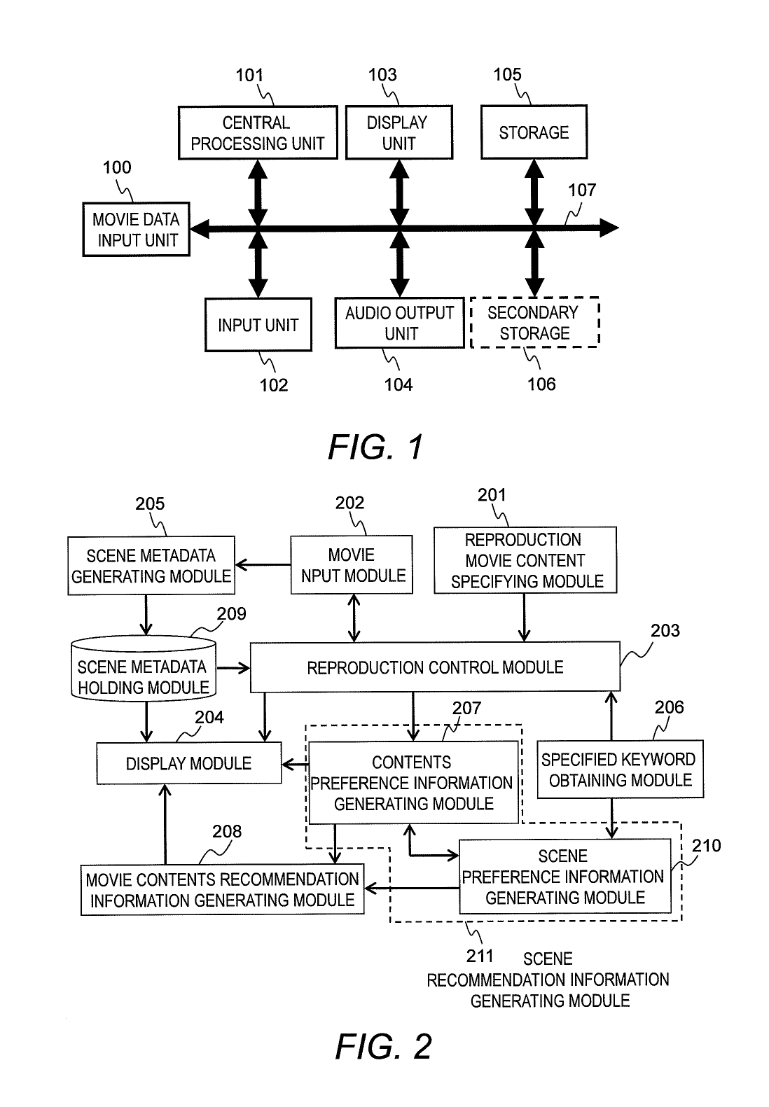

Embodiments of this invention are described below with reference to FIGS. 1 to 13.

### First Embodiment

FIG. 1 is a hardware configuration diagram of a movie recommendation system according to a first embodiment of this invention.

The movie recommendation system of this embodiment is, for example, a television set having a recording function, and includes a movie data input unit 100, a central processing unit 101, an input unit 102, a display unit 103, an audio output unit 104, storage 105, and secondary storage 106. The units are connected by a bus 107 to exchange data with one another.

The movie data input unit 100 is a module to which specified movie data among movie data that is stored in the storage 105 or the secondary storage 106 is input. The movie data input unit 100 is, for example, a module that reads movie data out of one of the storage 105 and the secondary storage 106, which are described later, or a tuner unit for a television set in the case where the movie recommendation system is designed to receive television broadcasting, or a network card such as a LAN card in the case where movie data is input to the movie recommendation system over a network.

The central processing unit 101 is constituted mainly of a microprocessor, and controls the operation of the movie recommendation system by executing software programs stored in the storage 105 and the secondary storage 106.

The input unit 102 is a device that receives an operation instruction from a user as an input. The input unit 102 is, for example, a remote controller, a keyboard, a touch panel, or the like.

The display unit 103 is, for example, a display adapter and a liquid crystal panel or a projector that is connected to the display adapter. The display unit 103 displays movie data input to the movie data input unit 100 or a screen on which the user enters an instruction by operating the input unit 102.

The audio output unit 104 is, for example, a sound card and a speaker, or the like, and outputs sound contained in movie data that is input to the movie data input unit 100.

The storage 105 is, for example, a volatile memory such as a random access memory (RAM), and stores software programs executed by the central processing unit 101, data processed in the movie recommendation system, and movie data reproduced by the movie recommendation system.

The secondary storage 106 is a hard disk drive, or an optical disc drive in which a DVD or a CVD is loaded, or a non-volatile memory such as a flash memory. The secondary storage 106 stores software programs executed by the central processing unit 101, data processed in the movie recommendation system, and movie data that can be reproduced by the movie recommendation system. The secondary storage 106 may be omitted in the case where movie data input to the movie data input unit 100 is not to be accumulated within the movie recommendation system.

The movie recommendation system of this invention is applicable to other machines capable of reproducing movie data than a television set, such as a hard disk recorder, a videotape recorder, a personal computer, or a cell phone. When the movie recommendation system is a hard disk recorder or a videotape recorder, the display unit 103 and the audio output unit 104 may be omitted from among the components described above.

FIG. 2 is a block diagram illustrating functions of the movie recommendation system according to this embodiment. The functions illustrated in FIG. 2 are implemented by the central processing unit 101 described above by executing software programs that are stored in the storage. Some or all of the functions may be implemented by hardware.

The movie recommendation system of this embodiment includes a reproduction movie content specifying module 201, a movie input module 202, a reproduction control module 203, a display module 204, a scene metadata generating module 205, a specified keyword obtaining module 206, a contents preference information generating module 207, a movie contents recommendation information generating module 208, a scene metadata holding module 209, a scene preference information generating module 210, and a scene recommendation information generating module 211.

The reproduction movie content specifying module 201 receives from the user an instruction specifying which of a plurality of movie contents available for reproduction is to be reproduced.

The movie input module 202 receives as an input from the movie data input unit 100 a movie content requested by the reproduction control module 203, and a movie content for which metadata is generated by the scene metadata generating module 205. The movie input module 202 outputs a movie content (movie data) that has been input to the movie input module 202 to the reproduction control module 203 and the scene metadata generating module 205.

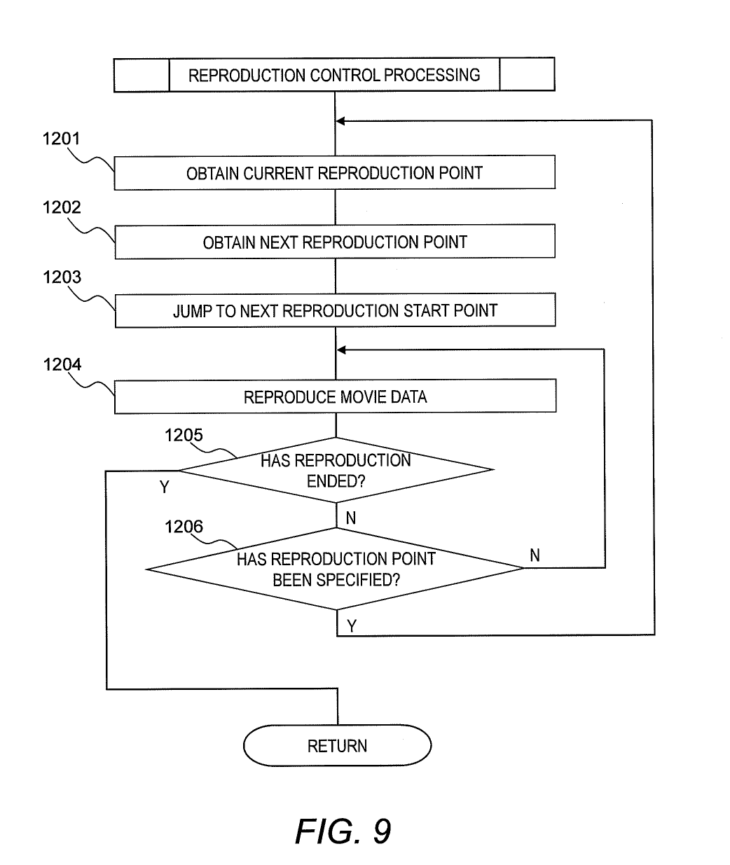

The reproduction control module 203 instructs the movie input module 202 to input a movie content specified by the reproduction content specifying module 201, generates reproduction images and reproduction sound from movie data input to the movie input module 202, and outputs the generated images and sound to the display unit 102 and the audio output unit 104, to thereby reproduce the images and audio. Details of reproduction processing are described later with reference to FIG. 9.

The display module 204 is a driver that outputs image data to the display unit 103. The display module 204 displays images of a reproduction movie content that are output from the reproduction control module 203, and displays a selection screen that contains scene metadata held in the scene metadata holding module 209. For example, the display module 204 displays a list of keywords of scene metadata to prompt the user to select a keyword. The display module 204 also displays a selection screen that contains recommendation information generated by the scene recommendation information generating module 211 and recommendation information generated by the movie contents recommendation information generating module 208.

The scene metadata generating module 205 generates metadata that associates a scene point and a keyword from movie data input to the movie input module 202, and outputs the generated scene metadata to the scene metadata holding module 209. Details of scene metadata are described later.

The specified keyword obtaining module 206 obtains keyword information specified by the user on a scene metadata (keyword) selection screen, which is displayed by the display module 204, and outputs the obtained keyword information to the reproduction control module 203 and the scene preference information generating module 210.

The contents preference information generating module 207 generates contents preference information from a movie content input to the movie input module 202. The degree of preference is a numerical value that indicates the level of preference of the user. Contents preference information contains a keyword and the degree of preference the user has for the keyword. Details of contents preference information are described later with reference to FIG. 4.

The movie contents recommendation information generating module 208 generates movie contents recommendation information by using one or both of contents preference information, which is generated by the contents preference information generating module 207, and scene preference information, which is generated by the scene preference information generating module 210. The movie contents recommendation information generating module 208 outputs the generated movie contents recommendation information to the display module 204.

The scene metadata holding module 209 holds the generated scene metadata and outputs the held scene metadata to the display module 204 and the reproduction control module 203.

The scene preference information generating module 210 generates scene preference information by assigning a degree of preference to a specified keyword input to the specified keyword obtaining module 206. The degree of preference is a numerical value that indicates the level of preference of the user. Scene preference information contains a keyword and the degree of preference the user has for the keyword. Details of scene preference information are described later with reference to FIG. 4. Scene preference information has the same configuration as contents preference information.

The scene recommendation information generating module 211 generates scene recommendation information by using one or both of contents preference information, which is generated by the contents preference information generating module 207, and scene preference information, which is generated by the scene preference information generating module 210. The scene recommendation information generating module 211 outputs the generated scene recommendation information to the display module 204.

Similarly to contents preference information and scene preference information, scene recommendation information contains a keyword and the degree of preference the user has for the keyword. The display module 204 displays scene recommendation information on the display unit 103, thereby enabling the user to specify a keyword from among keywords weighted by the degree of preference. This frees the user from the trouble of looking for a keyword of the user's interest on an unorganized list of keywords, which is the norm in prior art when specifying a keyword, and the user can thus specify a keyword with simple operation. Details of scene recommendation information are described later with reference to FIG. 4.

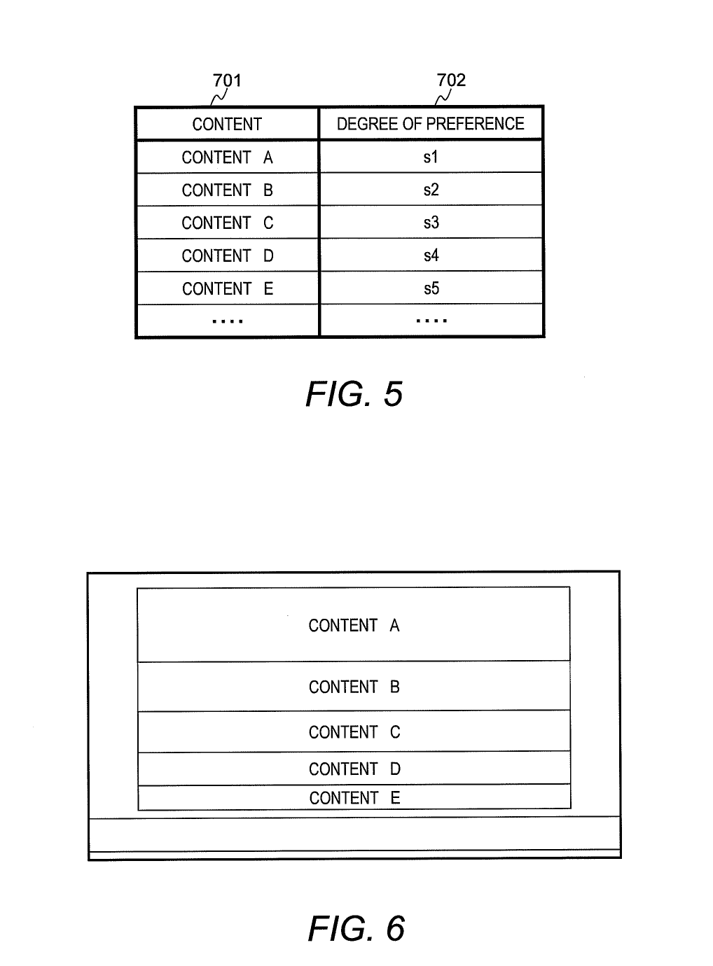

Movie contents recommendation information contains a movie content and the degree of preference the user has for the movie content. The degree of preference for a movie content can be the sum of the degrees of preference that are assigned to keywords contained in the movie content. The display module 204 displays movie contents recommendation information on the display unit 103, thereby enabling the user to specify a movie content of the user's interest from among movie contents weighted by the degree of preference. Details of movie contents recommendation information are described later with reference to FIG. 5.

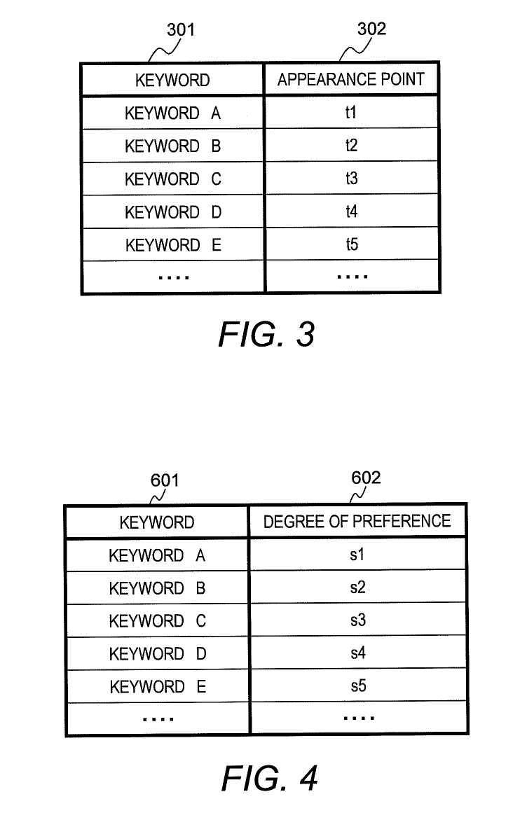

Next, referring to FIGS. 3 to 5, the generation of scene recommendation information and movie contents recommendation information is described.

First, with reference to FIG. 3, scene metadata which is generated by the scene metadata generating module 205 and held in the scene metadata holding module 209 is described. FIG. 3 is a diagram illustrating an example of the configuration of scene metadata.

Scene metadata contains a keyword 301 and an appearance point 302 of a scene that is associated with the keyword.

The keyword 301 is information contained in a scene which constitutes a part of a movie content, and is extracted from the sound, telop text, subtitles, and the like of the movie content. The appearance point 302 indicates the time elapsed from the start of the movie content until a scene associated with the keyword begins. One keyword is associated with one piece of appearance point information in FIG. 3. Instead, one keyword may be associated with a plurality of pieces of appearance point information.

A concrete example is given to describe scene metadata. In the case of a movie content that is a music program, the program is constituted mainly of singing scenes and the singing scenes can be divided by singers. Scene metadata in this case can contain as the keyword 301 the name of a singer who performs on the program and, as the appearance point 302, a time at which the singer starts singing. In the case of a movie content that is an information program covering a plurality of topics, scene metadata can contain as the keyword 301 a word (or a phrase) that represents a topic such as “losing weight” or “Kyoto” and, as the appearance point 302, a time at which the word (or a phrase) is uttered or appears on the screen.

Contents preference information generated by the contents preference information generating module 207, scene preference information generated by the scene preference information generating module 210, and scene recommendation information generated by the scene recommendation information generating module 211 are described next.

FIG. 4 is a diagram illustrating an example of the configuration of contents preference information, scene preference information, and scene recommendation information.

Contents preference information, scene preference information, and scene recommendation information each contain a keyword 601 and a degree of preference 602 the user has for the keyword.

The keyword 601 is the same as the one used for the keyword 301, which has been described above as a component of scene metadata. The degree of preference 602 is a numerical value indicating how much interest the user has in each keyword stored as the keyword 601, namely, the level of preference. The degree of preference 602 is set based on the history of reproduction movie contents and keywords that have been specified by the user, in a manner that gives a high degree of preference to a repeatedly chosen keyword.

Described in this embodiment is a case in which contents preference information and scene preference information are taken into consideration in generating scene recommendation information.

First, a movie content to be reproduced is selected by the user. Contents preference information is then generated.

To generate contents preference information, the degree of preference for a keyword can be calculated by obtaining the history of movie data input to the movie input module 202, the history of the user's operation performed on movie contents, and additional information about movie contents such as Electronic Program Guide. The calculation of contents preference information can use, for example, the method described in JP 2000-13708 A and JP 2007-96560 A.

Specifically, a keyword contained in information of a movie content that is viewed, recorded, or reproduced frequently is determined as a keyword for which the user has a strong preference, and the degree of preference is calculated based on the frequency of reproduction or other types of operation performed on the movie, the frequency of reproduction or other types of operation performed on a program whose data contains all keywords assigned to the movie content, and the like.

The degree of preference may be obtained also by compiling scene preference information, which is obtained from a specified keyword, and contents preference information, which is obtained from the operation history and program information.

Specifically, keywords contained in a reproduction movie content that is specified by the user are uniformly given one point as the degree of preference. Alternatively, a keyword may be given points multiplied by the number of times the keyword appears in the same reproduction movie content. In this case, a degree of preference s1 for a keyword A which appears a larger number of times than another keyword is greater than the degree of preference for the other keyword. The degree of preference for a keyword may also be varied depending on the genre of a reproduction movie content that contains the keyword and the type of the keyword. In the case of a drama, for example, keywords that are cast names may be given points weighted more heavily than the points of other keywords. In the case of a travel program, keywords that are geographical names may be given points weighted more heavily than the points of other keywords. By varying the weighting of keywords in the same movie content in this manner, the user's preference is reflected more closely.

Another option is to assign a higher degree of preference (for example, ten points) to a keyword specified by the user than those of keywords extracted from movie contents. In addition, a keyword that appears more than once may be given a value that is calculated by multiplying points per appearance by the number of times the keyword appears.

Specifically, in the case where the keyword A and a keyword B each appear twice, each of the other keywords, C to E, appears once, and the user specifies the keyword A, the degree of preference s1 for the keyword A is twenty-two points, a degree of preference s2 for the keyword B is two points, and degrees of preference s3 to s5 for the keywords C to E are each one point. In this manner, points are integrated and a high degree of preference is set to a keyword associated with a scene that is viewed often by the user.

The case described above, where the degree of preference is calculated by adding contents preference information and scene preference information on a one-on-one basis, is merely one way of using scene preference information and contents preference information both in the calculation of the degree of preference. The degree of preference may be calculated by weighting one of scene preference information and contents preference information. For example, in the case where scene preference information gives T1 to a keyword as the degree of preference and contents preference information gives T2 to the keyword as the degree of preference, the degree of preference for this keyword is calculated by α·T1+β·T2. If the values of α and β are varied depending on the characteristics of the keywords, the degree of preference that places importance on one of scene preference information and contents preference information is obtained. The characteristics of a keyword can be classified based on the program genre or the like. If α or β is set to 0, only one of scene preference information and contents preference information is used in the calculation of the degree of preference. The degree of preference calculated by the methods described above is used in the display of keywords in the order of priority in scene metadata and the generation of movie contents recommendation information which are described later.

In music programs, standup comedy programs, baseball game and other sports programs, an appearance scene of a performer or a player can be separated clearly from other scenes. Movie contents of this type are therefore in many cases viewed with the name of a performer or a player specified as a keyword, and precise scene preference information can be obtained with respect to the keyword.

With contents preference information, on the other hand, it is difficult to determine at an early stage which of a plurality of performers contained in movie content information is strongly preferred by the user. In addition, movie content information is not a suitable source of a player name and other similar keywords. This makes it difficult to obtain contents preference information with respect to a keyword. Using scene preference information compensates these drawbacks and consequently improves the precision of movie contents recommendation information generated by the movie contents recommendation information generating module 208.

Dramas and programs where a constant theme is maintained throughout are in many cases viewed from start to end, rather than only selected scenes. It is therefore not often that a keyword is specified in association with a scene of this type of program. This can make it difficult for the scene preference information generating module 210 to generate preference information with respect to the name of a drama cast member and other similar keywords. For these keywords, contents preference information is used to effectively present keywords for scene selection, which is described later.

Points given to a keyword as the degree of preference differ between contents preference information and scene preference information because the degree of preference of the user is higher for a keyword in a movie content that is specified by the user than a keyword that is contained in a reproduction movie content. The degree of preference set in this manner by heavily weighting a keyword that is specified by the user reflects the user's preference more accurately.

The degree of preference for a keyword is updated when the user selects a reproduction movie content and when the user specifies a keyword. The user's preference is therefore reflected more accurately as the number of times the user operates the movie recommendation system increases.

The precision of the user's preference information is also improved because contents preference information and scene preference information are taken into consideration in assigning the degree of preference to a keyword. For example, in the case of a movie content that is a music program, a standup comedy program, or other programs where an appearance scene of a performer can be separated clearly from an appearance scene of another performer, the user is likely to view the movie content specifying a particular performer. In this case, the degree of preference that puts emphasis on the performer that the user favors cannot be set in contents preference information, whereas an accurate degree of preference is assigned to the performer that the user favors in scene preference information. Conversely, it is difficult to obtain scene preference information in the case of a movie content that is a drama or other programs likely to be viewed from start to end. However, contents preference information for this type of movie content is obtainable, and the user's preference information of some precision is obtained as a result. By using contents preference information and scene preference information in this manner, the user's preference can be translated accurately into numerical values as the degree of preference.

Next, movie contents recommendation information generated by the movie contents recommendation information generating module 208 is described.

FIG. 5 is a diagram illustrating an example of the configuration of movie contents recommendation information.

Movie contents recommendation information contains a content 701 and a degree of preference 702 that the user has for the content. Contents in movie contents recommendation information are sorted in descending order of values stored as the degree of preference 702.

The content 701 is information for identifying a movie content, such as a title, an air date, and a content type. Movie contents whose information is registered as the content 701 are movie contents available for selection and reproduction by the user, and include programs scheduled to be aired, recorded programs, and net movies.

The degree of preference 702 is a numerical value indicating how much interest the user is likely to have in each movie content stored as the content 701, namely, the level of the user's preference. The degree of preference 702 can be the sum of the degrees of preference of the user for keywords contained in the movie content. Specifically, in the case where a content A contains the keyword A, which has a degree of preference TA, and the keyword B, which has a degree of preference TB, the degree of preference for the content A can be defined as TA+TB. In the case where the numbers of times of appearance of the keywords A and B, which are NA and NB, respectively, are taken into consideration, the degree of preference of the content A is defined as TA×NA+TB×NB.

Movie contents recommendation information may contain additional information such as cast names, a genre, and movie content details. Movie contents recommendation information may also be generated for each movie content type.

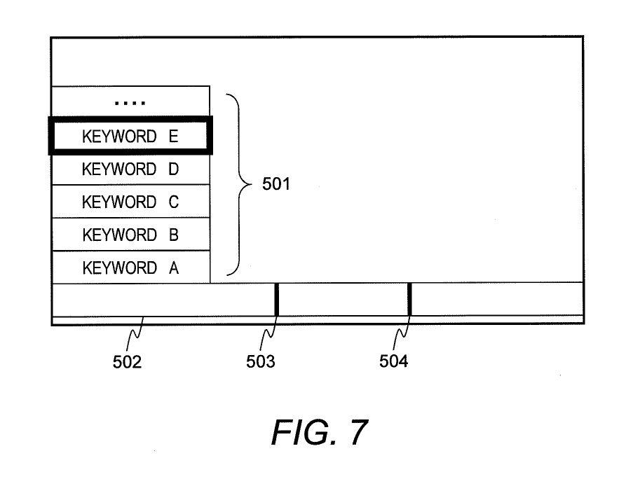

Referring to FIGS. 6 and 7, a concrete description is given next on how generated movie contents recommendation information and scene recommendation information are provided to the user.

FIG. 6 is a diagram illustrating an example of displaying movie contents recommendation information on the screen.

Movie contents recommended to the user are displayed in different display areas and different parts of the screen that are determined by the degree of preference, for example, in descending order of the degree of preference 702. The screen of FIG. 6 shows that the content A has the highest degree of preference. Specifically, the content A having the highest degree of preference is displayed in a display area larger than any of display areas of the other movie contents, in the top part of the screen. The color of the display area may be varied from one movie content to another. Varying the manner in which a movie content is displayed depending on the degree of preference helps the user to identify a movie content that has a high degree of preference.

Looking at the movie contents recommendation information display screen, the user operates the input unit 102 to select a movie content that is to be reproduced.

FIG. 7 is a diagram illustrating an example of displaying scene recommendation information on the screen.

The scene recommendation information screen is displayed after a movie content to be reproduced is selected on the screen of FIG. 6. Scenes recommended to the user are displayed such that a keyword 501 having a high degree of preference is placed in a part of the screen that is easy to select. For example, the keyword A which has the highest degree of preference is displayed in the bottom part of the screen where the operation of selecting is easy for the user. A time axis bar 502 is also displayed on the screen. Appearance point information 503 and appearance point information 504 of the keyword E, which is temporarily selected on the scene recommendation information display screen of FIG. 7, are displayed as markers on the time axis bar 502.

With keywords and scene points displayed in this manner, the user can easily grasp what keywords are contained and at which points the keywords appear.

Moreover, the number of markers 503 and 504 equals the appearance frequency of a keyword, and the user can select a scene based on not only the degree of preference for a keyword but also the appearance frequency of the keyword.

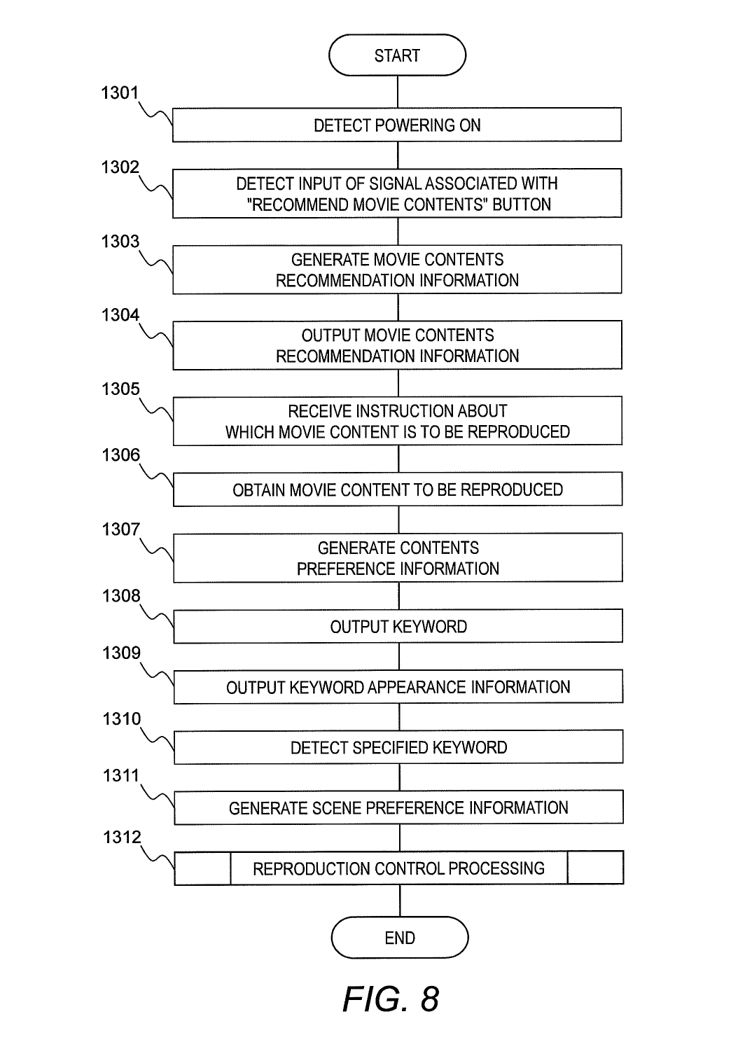

Referring to a flow chart, processing executed by the movie recommendation system according to the first embodiment is described next. FIG. 8 is a flow chart illustrating the concrete operation of the movie recommendation system according to the first embodiment. This operation is implemented by the central processing unit 101 by executing a program stored in the storage 105.

First, the powering on of the television set is detected and then the operation of a “recommend movie contents” button is detected (Step 1302). The “recommend movie contents” button is operated by the user when the user wants the movie recommendation system to present recommended movie contents from among recorded movie contents, and is provided in a remote controller or a similar component operated by the user.

Thereafter, the movie contents recommendation information generating module 208 generates movie contents recommendation information (Step 1303), and outputs the generated movie contents recommendation information to the display module 204 (Step 1304). The output movie contents recommendation information is displayed on the display screen of a television set or the like as illustrated in FIG. 6.

The reproduction movie content specifying module 201 then receives an instruction specifying which movie content is to be reproduced (Step 1305). Which movie content is to be reproduced is selected by the user from the movie contents recommendation information displayed on the television screen. In this step of receiving an instruction specifying a movie content, the display module 204 displays on the display unit 103 a list of movie contents recorded in the storage 105 or the secondary storage 106 and available for reproduction (e.g., the movie contents recommendation information screen of FIG. 6). The user then uses the input unit 102 to select a movie content on the list, thereby specifying which movie content is to be reproduced.

The movie input module 202 obtains the movie content to be reproduced (Step 1306).

Next, the contents preference information generating module 207 generates contents preference information (Step 1307). Information of the input movie content may be saved to generate contents preference information at a time later or earlier than when the movie content is reproduced.

The scene recommendation information generating module 211 outputs keywords (Step 1308). Keywords output in this step are displayed on the scene recommendation information display screen (illustrated in FIG. 7) in descending order of the degree of preference based on scene recommendation information.

The scene recommendation information generating module 211 next outputs keyword appearance information (Step 1309). Keyword appearance information is information about a point at which a scene containing a keyword begins, and is expressed as the time elapsed since the start of the relevant movie content. In this embodiment, when the user temporarily selects a keyword displayed on the screen as in FIG. 7 before deciding on which keyword to choose, appearance information of this keyword is displayed on the time axis bar 502 on the scene recommendation information display screen.

After the user specifies a keyword by operating the input unit 102, the specified keyword obtaining module 206 detects the keyword specified by the user (Step 1310).

The scene preference information generating module 210 generates scene preference information based on the specified keyword, and saves the generated information in the memory (Step 1311). Information of the specified keyword may be saved to generate scene preference information at a time later or earlier than when the movie content is reproduced.

The reproduction control module 203 executes reproduction control processing of the movie content to be reproduced (Step 1312). The reproduced movie content is output to the display module 204 and displayed on the display unit 103.

Next, the reproduction control processing of Step 1312 is described.

FIG. 9 is a flow chart illustrating the reproduction control processing. The reproduction control processing of FIG. 9 is implemented by the central processing unit 101 by executing a movie reproduction software program, which is stored in the storage 105. More specifically, the reproduction control processing is executed by the reproduction control module 203.

First, the current reproduction point is obtained (Step 1201) and the next reproduction start point is obtained (Step 1202). A point in a movie content is expressed as the time elapsed since the start of the movie content. The next reproduction start point is obtained by referring to the appearance point 302 of the keyword 301 in the scene metadata holding module 209 and retrieving a point after the current reproduction point that is closest to the current reproduction point.

The processing then jumps to the next reproduction start point (Step 1203) to reproduce the movie data from this reproduction start point on (Step 1204). Specifically, reproduction images of the movie data that follow the reproduction start point are output from the display module 204 to be displayed on the display unit 103. Reproduction sound of the movie data that follows the reproduction start point is also output to the audio output unit 104.

Whether or not reproduction has ended is determined next (Step 1205). This determination of the end of reproduction is executed repeatedly in a loop. When reproduction is ended, the reproduction control processing is finished. Specifically, the reproduction control processing is finished when the movie data has been reproduced to the end, or when a viewing ending instruction issued from the user by, for example, operating an “end reproduction” button is received.

Next, whether or not a reproduction point has been specified is determined (Step 1206). This determination of the presence or absence of a specified reproduction point is executed repeatedly in a loop. In the case where a reproduction point has been specified, the processing returns to Step 1201 to reproduce the movie content from the specified reproduction point. In the case where an instruction to change the reproduction point has not been issued, the processing returns to Step 1204 to continue reproducing the movie content. In this reproduction control processing, frames of movie images are reproduced in a successive manner until a new reproduction point is specified.

As described above, in the movie recommendation system according to the first embodiment, the contents preference information generating module 207 generates contents preference information by assigning degrees of preference to keywords that are contained in a movie content specified by the user to be reproduced. The scene preference information generating module 210 generates scene preference information by assigning a degree of preference to a keyword that is specified by the user to select out of a reproduction movie content a scene that the user wants to view. By assigning degrees of preference of the user to keywords in this manner, the user's movie contents preference and the scene preference both can be measured. This enables the scene recommendation information generating module 211 and the movie contents recommendation information generating module 208 to respectively generate scene recommendation information and movie contents recommendation information by combining contents preference information and scene preference information.

The movie recommendation system of the first embodiment recommends to the user movie contents that have high degrees of preference of the user from among many movie contents available for reproduction. The recommended movie contents are displayed on the screen in a manner that shows the degree of preference of the user. Looking at the screen, the user can thus easily select a movie content that is highly likely to match his/her preference.

The movie recommendation system of the first embodiment recommends to the user scenes that have high degrees of preference of the user in a reproduction movie content selected by the user. The degrees of preference of the user for scenes are the degrees of preference of the user that are assigned to keywords associated with the scenes. The keywords are displayed on the screen in a manner that makes it easy for the user to select a keyword that has a high degree of preference. When the user temporarily selects a keyword, an appearance point of the keyword is displayed on the time axis bar on the screen. The user can thus easily select a scene in the reproduction movie content that matches his/her preference. In addition, the user can select an appearance point marker on the time axis bar to reproduce the movie content from the scene of the appearance point. This enables the user to view movie contents efficiently by reproducing only scenes that match his/her preference and that he/she wants to view.

Further, the degree of preference of the user for a scene or a movie content is assigned to a keyword contained in a reproduction movie content that is selected by the user, or a keyword specified by the user. The degree of preference of the user is integrated as the number of times the scene or the movie content is selected by the user increases. In other words, the degree of preference is assigned to a movie content or a scene that is selected by the user, ensuring that a high degree of preference is set to a keyword that matches the user's preference. This increases the probability of a scene or a movie content that is recommended to the user matching the preference of the user.

Thus, the movie recommendation system of the first embodiment enables the user to select a movie content that matches his/her preference and, with simple operation, to efficiently view only a scene that matches his/her preference within the movie content.

### Second Embodiment

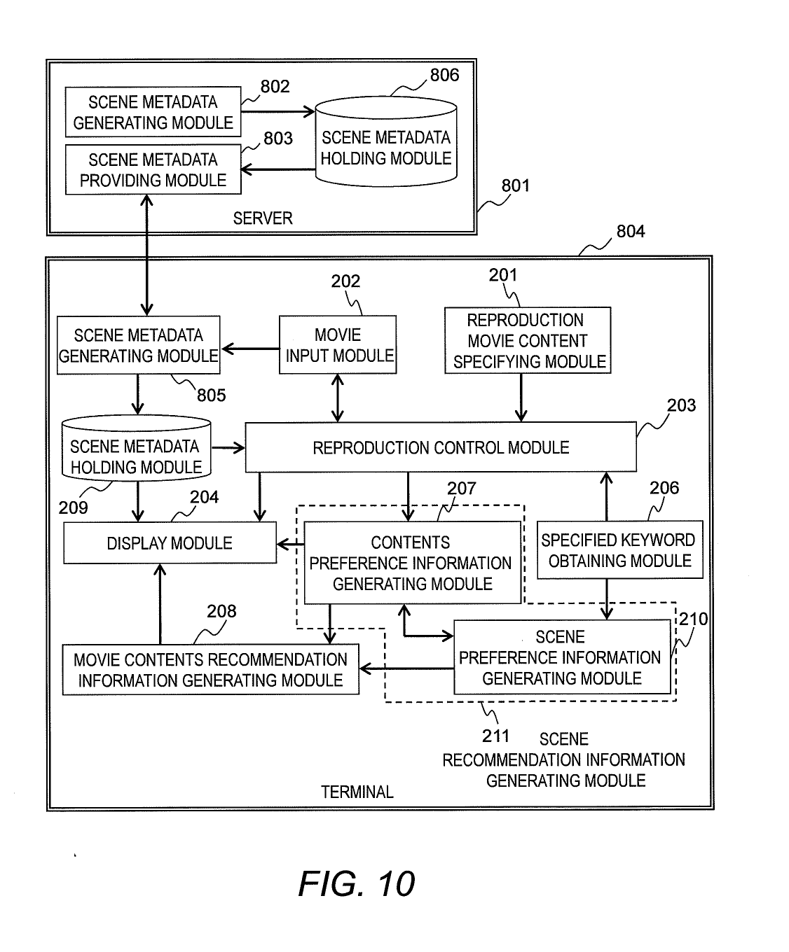

FIG. 10 is a block diagram illustrating functions of the movie recommendation system according to a second embodiment of this invention.

Scene metadata, which, in the first embodiment described above, is generated by a movie recommendation device (terminal), may be generated by a server instead of the terminal. The second embodiment deals with an example of generating scene metadata by the server. In the following description, components that implement the same functions as those in the first embodiment are denoted by the same reference symbols, and their descriptions are omitted here.

The movie recommendation system of the second embodiment includes a server 801 and a terminal 804.

The server 801 is a computer that includes a microprocessor, storage (memory), auxiliary storage (magnetic disk drive), and a communication interface. The server 801 also includes a scene metadata generating module 802, a scene metadata providing module 803, and a scene metadata holding module 806.

The scene metadata generating module 802 generates scene metadata and stores the generated metadata in the scene metadata holding module 806. The scene metadata providing module 803 reads, out of the scene metadata holding module 806, scene metadata of a movie content requested from the terminal 804, and transmits the read metadata to a scene metadata obtaining module 805 of the terminal 804.

The scene metadata generating module 802 and the scene metadata providing module 803 are implemented by the microprocessor by executing software programs that are stored in the memory. The scene metadata holding module 806 is a storage area provided in the auxiliary storage.

Scene metadata generation in the scene metadata generating module 802 may be executed manually based on a keyword that symbolizes a scene contained in a movie content and an appearance point of the keyword, or may be executed by the method described in JP 2009-77322 A.

The terminal 804 includes the scene metadata obtaining module 805, the reproduction movie content specifying module 201, the movie input module 202, the reproduction control module 203, the display module 204, the specified keyword obtaining module 206, the contents preference information generating module 207, the movie contents recommendation information generating module 208, the scene metadata holding module 209, the scene preference information generating module 210, and the scene recommendation information generating module 211.

In the terminal 804, scene metadata obtained from the server 801 by the scene metadata obtaining module 805 is stored in the scene metadata holding module 209, and the stored scene metadata is used to execute the same processing as in the first embodiment.

### Third Embodiment

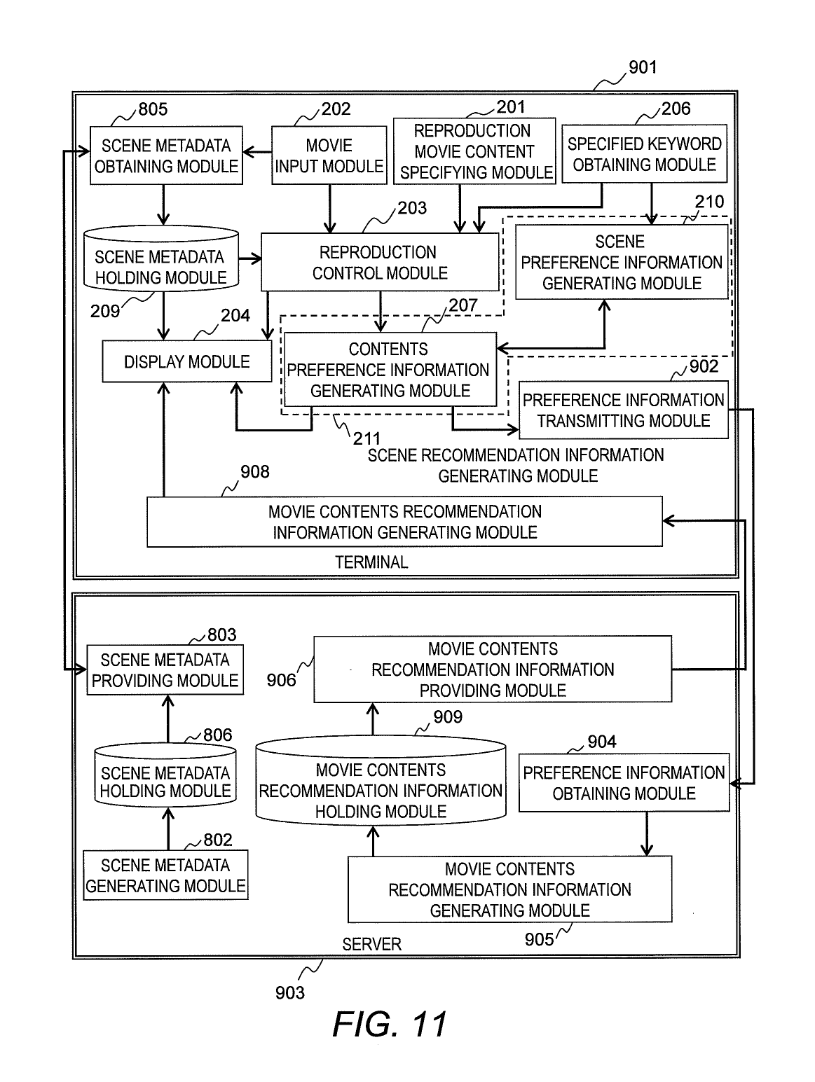

FIG. 11 is a block diagram illustrating functions of a movie recommendation system according to a third embodiment of this invention.

Movie contents recommendation information, which, in the first embodiment described above, is generated by a movie recommendation device (terminal), may be generated by a server instead of the terminal. The third embodiment deals with an example of generating the movie contents recommendation information by the server. In the following description, components that implement the same functions as those in the first and second embodiments are denoted by the same reference symbols, and their descriptions are omitted here.

The movie recommendation system of the third embodiment includes a server 903 and a terminal 901.

The server 903 includes the scene metadata generating module 802, the scene metadata providing module 803, the scene metadata holding module 806, a movie contents recommendation information providing module 906, a preference information obtaining module 904, a movie contents recommendation information generating module 905, and a movie contents recommendation information holding module 909.

The preference information obtaining module 904 receives preference information transmitted from a preference information transmitting module 902 of the terminal 901. The movie contents recommendation information generating module 905 generates movie contents recommendation information based on the received preference information. The movie contents recommendation information providing module 906 transmits movie contents recommendation information to a movie contents recommendation information obtaining module 908 of the terminal 901. The rest of the components of the server 903 are the same as those in the second embodiment.

The terminal 901 includes the scene metadata obtaining module 805, the reproduction movie content specifying module 201, the movie input module 202, the reproduction control module 203, the display module 204, the specified keyword obtaining module 206, the contents preference information generating module 207, the movie contents recommendation information generating module 208, the scene metadata holding module 209, the scene preference information generating module 210, and the scene recommendation information generating module 211.

The movie contents recommendation information generating module 905 generates movie contents recommendation information by the same method that is used by the movie contents recommendation information generating module 208 of the first embodiment to generate movie contents recommendation information.

The movie contents recommendation information generating module 905 may generate movie contents recommendation information based on information of a plurality of users, after obtaining preference information from a plurality of terminals and processing the preference information through ranking by popularity and collaborative filtering.

While the server 903 generates scene metadata in the third embodiment, scene metadata may be generated on the terminal 901 by providing the terminal 901 with the scene metadata generating module.

### Fourth Embodiment

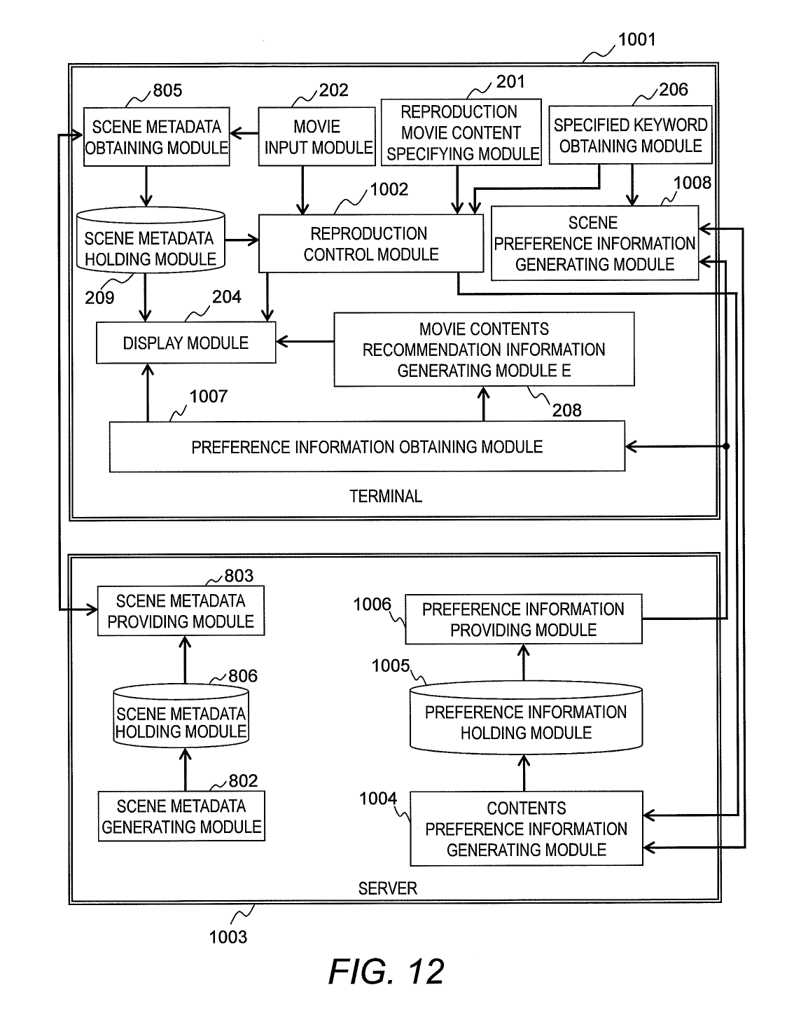

FIG. 12 is a block diagram illustrating functions of a movie recommendation system according to a fourth embodiment of this invention.

Contents preference information, which, in the first embodiment described above, is generated by a movie recommendation device (terminal), may be generated by a server instead of the terminal. The fourth embodiment deals with an example of generating contents preference information by the server. In the following description, components that implement the same functions as those in the first to third embodiments are denoted by the same reference symbols, and their descriptions are omitted here.

The movie recommendation system of the fourth embodiment includes a server 1003 and a terminal 1001.

The server 1003 includes the scene metadata generating module 802, the scene metadata providing module 803, the scene metadata holding module 806, a contents preference information generating module 1004, a preference information holding module 1005, and a preference information providing module 1006. The terminal 1001 includes the scene metadata obtaining module 805, the reproduction movie content specifying module 201, the movie input module 202, a reproduction control module 1002, the display module 204, the specified keyword obtaining module 206, the movie contents recommendation information generating module 208, the scene metadata holding module 209, and a scene preference information generating module 1008.

The reproduction control module 1002 of the terminal 1001 transmits, to the contents preference information generating module 1004 of the server 1003, the history of reproduction and other types of operation and scene preference information obtained from a specified keyword.

The contents preference information generating module 1004 generates preference information based on the received information (operation history and scene preference information), and stores the generated information in the preference information holding module 1005. The contents preference information generating module 1004 generates preference information by the same method that is used by the contents preference information generating module 207 of the first embodiment to generate preference information. Preference information of a plurality of users may also be generated by, for example, collecting preference information from a plurality of terminals and obtaining a generally popular keyword (a keyword high in degree of preference).

The preference information providing module 1006 transmits preference information stored in the preference information holding module 1005 to a preference information obtaining module 1007 and the scene preference information generating unit 1008 of the terminal 1001. The rest of the components of the terminal 1001 are the same as those in the movie recommendation system (the terminal 901) of the third embodiment.

While the server 1003 generates scene metadata in the fourth embodiment, scene metadata may be generated on the terminal 1001 by providing the terminal 1001 with the scene metadata generating module.

### Fifth Embodiment

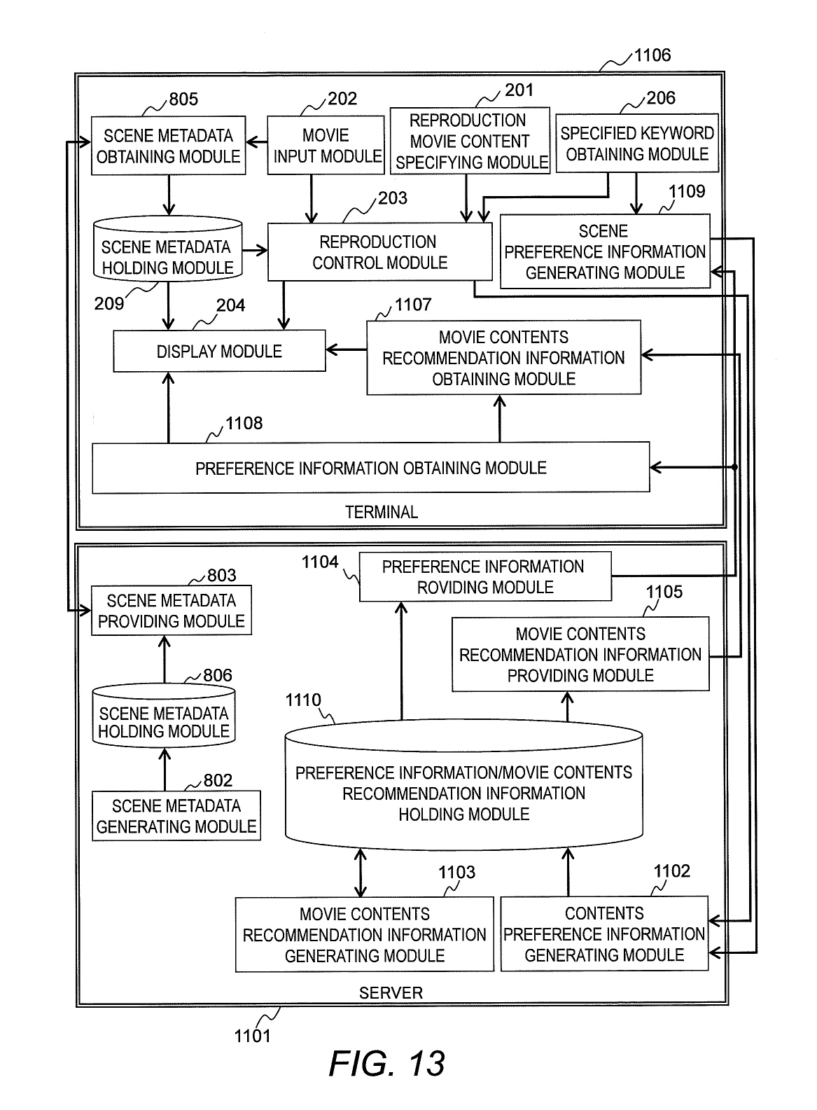

FIG. 13 is a block diagram illustrating functions of a movie recommendation system according to a fifth embodiment of this invention.

Content preference information and movie contents recommendation information, which, in the first embodiment described above, are generated by a movie recommendation device (a terminal), may be generated by a server instead of the terminal. The fifth embodiment deals with an example of generating content preference information and movie contents recommendation information on the server. In the following description, components that implement the same functions as those in the first to fourth embodiments are denoted by the same reference symbols, and their descriptions are omitted here.

The movie recommendation system of the fifth embodiment includes a server 1101 and a terminal 1106.

The server 1101 includes the scene metadata generating module 802, the scene metadata providing module 803, the scene metadata holding module 806, a contents preference information generating module 1102, a movie contents recommendation information generating module 1103, a preference information providing module 1104, a movie contents recommendation information providing module 1105, and a preference information/movie contents recommendation information holding module 1110. The terminal 1106 includes scene metadata obtaining module 805, the reproduction movie content specifying module 201, the movie input module 202, the reproduction control module 1002, the display module 204, the specified keyword obtaining module 206, the scene metadata holding module 209, a movie contents recommendation information obtaining module 1107, a preference information obtaining module 1108, and a scene preference information generating module 1109.

As in the fourth embodiment described above, the contents preference information generating module 1102 of the server 1101 receives information (operation history and scene preference information) from the reproduction control module 1002 and the scene preference information generating module 1009 of the terminal 1106 and generates preference information. The generation of preference information is the same as in the fourth embodiment.

The movie contents recommendation information generating module 1103 generates movie contents recommendation information based on preference information generated by the contents preference information generating module 1102, and stores the generated information in the preference information/movie contents recommendation information holding module 1110. The generation of the movie contents recommendation information is the same as in the third embodiment.

The preference information providing module 1104 transmits preference information stored in the preference information/movie contents recommendation information holding module 1110 to the preference information obtaining module 1108 and the scene preference information generating module 1109 of the terminal 1106.

The movie contents recommendation information providing module 1105 transmits movie contents recommendation information stored in the preference information/movie contents recommendation information holding module 1110 to the movie contents recommendation information obtaining module 1107 of the terminal 1106.

Based on the data (scene preference information and movie contents recommendation information) obtained by the preference information obtaining module 1108 and the movie contents recommendation information obtaining module 1107, display processing is executed in the same manner as in the first embodiment.

While the server 1101 generates scene metadata in the fifth embodiment, scene metadata may be generated on the terminal 1106 by providing the terminal 1106 with the scene metadata generating module.

Scene preference information is generated on a terminal in the second to fifth embodiments described above. Alternatively, a server may generate scene preference information by providing the server with a scene preference information generating module. This invention can thus be configured to execute all of scene metadata generation, preference information generation, and movie contents recommendation information generation on the terminal side, and can also be configured to execute some of the three on the server side.

According to the embodiments of this invention, a user can view, efficiently, with simple operation, only movie contents and scenes in movie contents that match the user's preference.

While the present invention has been described in detail and pictorially in the accompanying drawings, the present invention is not limited to such detail but covers various obvious modifications and equivalent arrangements, which fall within the purview of the appended claims.

What is claimed is:

1. A movie recommendation system, comprising:
a processor for executing a software program;
a memory for storing the software program;
an output unit for outputting movies to be presented to the user; and
an input unit for receiving an input from the user,
wherein the movie recommendation system includes:
a scene metadata obtaining module for obtaining metadata which contains keywords associated with scenes, and time axis information indicating times at which the keywords appear, the scenes included in a movie content;
a movie content information obtaining module for obtaining information of a movie content to be reproduced by a user;
a contents preference information obtaining module for obtaining contents preference information, which is generated by assigning preference of the user to the keywords that are contained in the obtained metadata, based on the obtained information of the movie content; and
a scene recommendation module for outputting at least one keyword preferred by the user from among the keywords contained in the movie content, based on the obtained contents preference information, in association with a scene recommended to the user.

2. The movie recommendation system according to claim 1, further comprising:
a keyword obtaining module for obtaining a keyword specified by the user when the movie content is reproduced; and
a scene preference information generating module for generating scene preference information based on the obtained keyword, by assigning preference of the user to the keywords of the metadata,
wherein the scene recommendation module outputs at least one keyword preferred by the user from among the keywords contained in the movie content, based on the generated scene preference information, in association with a scene recommended to the user.

3. The movie recommendation system according to claim 2, further comprising:
a contents recommendation information obtaining module for obtaining contents recommendation information, which is generated by assigning preference of the user to the keywords that are contained in the movie content, based on the generated contents preference information and the generated scene preference information; and
a movie contents recommendation module for outputting, as a movie content recommended to the user, at least one movie content preferred by the user based on the obtained contents recommendation information.

4. The movie recommendation system according to claim 2, wherein the scene preference information is updated when the user specifies the keyword.

5. The movie recommendation system according to claim 1, further comprising:
a keyword obtaining module for obtaining a keyword specified by the user when the movie content is reproduced; and
a reproduction control module for reproducing a scene that is associated with the specified keyword.

6. The movie recommendation system according to claim 1, wherein the contents preference information is updated when the user specifies a movie content.

7. A movie recommendation system, comprising:
a processor for executing a program;
a memory for storing the program;
an output unit for outputting movies to be presented to the user; and
an input unit for receiving an input from the user,
wherein the movie recommendation system includes:
a scene metadata obtaining module for obtaining metadata which contains keywords associated with scenes, and time axis information of times at which the keywords appear, the scenes included in a movie content;
a movie content information obtaining module for obtaining information of a movie content to be reproduced by a user;
a keyword obtaining module for obtaining a keyword specified by the user when the movie content is reproduced;
a scene preference information generating module for generating scene preference information based on the obtained keyword, by assigning preference of the user to the keywords of the metadata;
a contents recommendation information obtaining module for obtaining contents recommendation information, which is generated by assigning preference of the user to the keywords that are contained in the movie content, based on the generated scene preference information; and
a movie contents recommendation module for outputting, as a movie content recommended to the user, at least one movie content preferred by the user based on the obtained contents recommendation information.

8. The movie recommendation system according to claim 7, further comprising a contents preference information obtaining module for obtaining contents preference information, which is generated by assigning preference of the user to the keywords that are contained in the obtained metadata, based on the obtained information of the movie content,
wherein the contents recommendation information obtaining module obtains contents recommendation information, which is generated by assigning preference of the user to the keywords that are contained in the movie content, based on the generated scene preference information and the obtained contents preference information.

9. A movie recommendation method for a movie recommendation system, which recommends a movie content to a user and which has a processor for executing a software program, a memory for storing the software program executed by the processor, an output unit for outputting movies to be presented to the user, and an input unit for receiving an input from the user, the movie recommendation method including:
a scene metadata obtaining step of obtaining metadata which contains keywords associated with scenes, and time axis information indicating times at which the keywords appear, the scenes included in a movie content;
a movie content information obtaining step of obtaining information of a movie content to be reproduced by the user;
a contents preference information obtaining step of obtaining contents preference information, which is generated by assigning preference of the user to the keywords that are contained in the obtained metadata, based on the obtained information of the movie content; and
a scene recommending step of outputting at least one keyword preferred by the user from among the keywords contained in the movie content, based on the obtained contents preference information, in association with a scene recommended to the user.

10. The movie recommendation method according to claim 9, further including:
a keyword obtaining step of obtaining a keyword specified by the user when the movie content is reproduced; and
a scene preference information generating step of generating scene preference information based on the obtained keyword, by assigning preference of the user to the keywords of the metadata,
wherein, in the scene recommending step, based on the generated scene preference information, at least one keyword preferred by the user from among the keywords contained in the movie content are output in association with a scene recommended to the user.

11. The movie recommendation method according to claim 10, further including:
a contents recommendation information obtaining step of obtaining contents recommendation information, which is generated by assigning preference of the user to keywords that are contained in the movie content, based on the obtained contents preference information and the generated scene preference information; and
a movie contents recommending step of outputting, as the movie content recommended to the user, at least one movie content preferred by the user based on the obtained contents recommendation information.

12. The movie recommendation method according to claim 10, wherein the scene preference information is updated when the user specifies the keyword.

13. The movie recommendation method according to claim 9, further including:
a keyword obtaining step of obtaining a keyword specified by the user when the movie content is reproduced; and
a reproduction control step of reproducing a scene that is associated with the specified keyword.

14. The movie recommendation method according to claim 9, wherein the contents preference information is updated when the user specifies a movie content.
